(19) United States
(12) Patent Application Publication
(10) Pub. No.: US 2003/0033263 A1
(43) Pub. Date: Feb. 13, 2003

(54) Automated learning system

(75) Inventor: John Gerald Cleary, Hamilton (NZ)

Correspondence Address: SUGHRUE MION, PLLC, 2100 Pennsylvania Avenue, NW, Washington, DC, 20037-3213, US

(73) Assignee: REEL TWO LIMITED

(21) Appl. No.: 10/207,787

(22) Filed: Jul. 31, 2002

(30) Foreign Application Priority Data
Nov. 26, 2001 (NZ) 515,680
Jul. 31, 2001 (NZ) 513,249

(51) Int. Cl. G06F 15/18

(52) U.S. Cl. 706/12

(57) ABSTRACT

The present invention relates to a method of implementing, using and also testing a machine learning system. Preferably the system employs the Naïve Bayesian prediction algorithm in conjunction with a feature data structure to provide probability distributions for an input record belonging to one or more categories. Elements of the feature data structure may be prioritized and sorted with a view to selecting relevant elements only for use in the calculation of a probability indication or distribution. A method of testing is also described which allows the influence of one input learning data record to be removed from the system with the same record being used to subsequently test the accuracy of the system.

### TECHNICAL FIELD

This invention relates to the provision of an automated learning system using a computer software algorithm or algorithms. Specifically the present invention may be adapted to provide computer software which can issue predictions or probabilities for the presence of particular types of data within a set of information supplied to the software, where the probability calculation is based on previous information supplied to, or experience of the system.

### BACKGROUND ART

Software tools have previously been developed for a wide range and variety of applications. To assist in the performance of such software, machine learning systems have been developed. These systems include algorithms that are adapted to improve the operational performance of computer software over time through learning from the experiences of the system or previous information supplied to the system.

Machine learning based systems have many different applications both in computer software and other related fields, such as for example, automation control systems. For instance, machine learning algorithms may be employed in recognition systems to identify specific elements of speech, text, objects in video footage. Alternatively, other applications for such systems can be in the “data mining” field where algorithms are employed to model or predict the behaviour of complex systems such as financial networks.

One path taken to implement such machine learning systems is through the use of probability algorithms that can be refined or improved over time. The algorithms used are provided with a learning data set that may have already been preclassified or sorted by human beings or other computer or automated system. The algorithms used can then calculate the probability of a data record falling within a particular classification or category based on the occurrence of specific elements of data within that record. The learning data to provide to the algorithm gives it feedback with regard to the accuracy of its own predictions and allows these predictions to be refined or improved as more learning data is supplied.

Such systems need not also calculate a specific probability value for a data record falling within a classification or category. Such systems can be employed to simply rank or order a series of data records for their relevance to a particular classification or category, without necessarily calculating specific probability values.

The development and training of such machine learning systems can however be relatively complicated and costly. The results of the system are totally dependent on the quality of the learning data that is supplied, so care and attention needs to be taken in the generation of such data. Furthermore, human input may be required to generate learning data that is a repetitive and slow process. This creates a labour cost, which in turn increases the cost of implementing such systems.

After the learning phase employed in the development of such systems has been completed, the systems operation will then need to be tested extensively to ensure that its results are accurate. Again this requires further human generated data to be supplied to the system and for the system to give back its predictions or results based on its previous ‘learning’ experiences. The data used in tests cannot be the same used to teach the system as this would in effect be giving the system the answers to the testing queries posed. As a result of this, a further cost is introduced to the development of such systems as they again require more data to validate what the system has learnt previously.

Furthermore, high accuracy in the results provided is very important to ensure that the system is trusted and employed extensively by its users. Learning based algorithms which can provide a highly accurate performance and which can be trained to learn accurately, fast and efficiently on the training data provided are sought after in this field.

An improved automated learning system that addressed any or all of the above issues would be of advantage.

It is an object of the present invention to address the foregoing problems or at least to provide the public with a useful choice.

Further aspects and advantages of the present invention will become apparent from the ensuing description that is given by way of example only.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Indicate the background art which, as far as known to the applicant, can be regarded as useful for the understanding, searching and examination of the invention, and, preferably, cite the documents reflecting such art. (Rule 5.1(a)(ii))

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a method of implementing a machine learning system through the creation of at least one feature data structure, characterised by the steps of;

(i) obtaining input data formed from a number of discreet records, each record containing a plurality of features, and

(ii) obtaining available category ratings for each record, wherein a category rating gives information relating to a category or categories which the record belongs to, and

(iii) identifying each of the features present within each record of the input data obtained, and

(iv) updating an element of a feature data structure associated with a particular feature identified with any category rating available for the record in which the feature occurred, and

(v) continuing to update the elements of the feature data structure with each feature of each record making up the input data.

According to a further aspect of the present invention there is provided a method of implementing a machine learning system through the creation of at least one feature data structure, characterised by the steps of:

(i) obtaining input data formed from a number of discrete records, each record containing a plurality of features, wherein each record belongs to at least one category, and

(ii) obtaining at least one category rating for each record, wherein a category rating gives information relating to the category or categories which each record belongs to, and

(iii) identifying each of the features present within each record of the input data obtained, and

(iv) updating an element of a feature data structure associated with a particular feature identified with at least one category rating of the record in which the feature occurred, and

(v) continuing to update the elements of the feature data structure with each feature of each record making up the input data.

The present invention is adapted to provide a method of implementing a machine learning system and also a method of using such a machine learning system. Preferably a system implemented in accordance with the present invention may use at least one software based algorithm to receive input or learning data. The input data used can be pre-analysed to provide information regarding the characteristics of the data that the system is to learn to recognise or work with.

In effect the machine learning system can accumulate the experiences or results of large numbers of people or other computer systems within one or more software data structures. The data structure or structures developed can then be used by the system with other independent sample data to obtain a prediction, identify a pattern or complete an analysis. Furthermore, such a data structure or structures may also be used to rank a series of input data records depending on their relevance to a particular category or type of information. The calculation of a probability value need not necessarily be considered essential in such embodiments. The data structure or structures developed may therefore in effect grow and increase in size as the system is provided with more input data, allowing the system to learn to be more accurate as more data is supplied to it.

Reference throughout this specification will also be made to the machine learning system being developed as a probability based prediction system, which preferably uses Naïve Bayesian prediction algorithms. Such a system may provide as an output a probability of a particular result being present in or being associated with sample data supplied to the system. Reference throughout this specification will also be made to the present invention being employed in a probability based prediction system, but those skilled in the art should appreciate that other applications for the invention may also be developed in some instances. For example, in another embodiment a value may be calculated which is indicative of probability, but is not necessarily normalised or calibrated to provide a probability value. In such instances the value calculated may be used to rank or prioritise a set of supplied sample data records.

To implement such a system input data must firstly be obtained which the system is to learn from and use to create at least one feature data structure. Preferably such input or learning data may take the form of a number of discrete records such as documents, computer files, speech pattern recordings, or sequences of video footage. For the sake of simplicity reference throughout this specification will be made to input data to the system being a number of distinct or discrete text based documents which are in turn composed of collections of words. However, those skilled in the art should appreciate that any number of different types or forms of input data records may also be analysed in conjunction with the present invention, and reference to the above only throughout this specification should in no way be seen as limiting.

Preferably each input data record supplied to the system contains a plurality of distinct identifiable features. A feature may be an identifiable characteristic of a record that a human being would use as a clue or indicator to classify the content of the record. Although a single feature of a record may not necessarily allow it to be classified, while a plurality of features of the record in combination will together give substantially the entire subject matter of the record and therefore allow the record to be classified. For example, where preferably a record is formed from a text document, the features of the record may be the distinct words specified within the document. Furthermore, features may also be composed of strings of words or phrases together or in proximity to one another within the document.

Preferably an input data record belongs to at least one category. A category may give a classification or abstract overview of the content or contents of the record and will be determined by the implementation of the machine learning system, and the application within which it is to perform. For example, if preferably input data records are formed from text documents the categories which the document may belong to could include cooking recipes, motor cycle repair manuals, telephone directories and documents written in the English language.

However, those skilled in the art should appreciate that an input data record need not necessarily belong to at least one category. For example, in some instances it may not be possible to categorise a particular record to the set of categories available. These uncategorisable records may still be encountered by the system involved, and hence may also be used as input learning data for same to allow the system to identify further uncategorisable records.

As should be appreciated by those skilled in the art a single record may belong to any number of categories which are in turn defined by the application or functions which the machine leaning system is to be used with or within.

Furthermore, the categorisation of records can be a relatively subjective process and may vary from person to person or between a person and some other automated system. Different people may feel that a particular record falls within completely different categories or may agree that on a single document falling into a single category, but disagree on other categories which they believe the document belongs to. The present invention preferably takes into account these variations in the analysis of records by summarising and collating large amounts of testing data. This collection of information can provide a statistical analysis of any input data supplied to it to categorise same.

Preferably in combination with learning data obtained for the system a category rating for each record within the data may also be obtained. Such a category rating may include information regarding the category or categories that the record may belong to. Furthermore, multiple category ratings may also be provided for the same record from different sources.

However, those skilled in the art should appreciate that some learning data records may be supplied which do not have any category ratings available for the record. If the record is uncategorisable then no category ratings can in fact be supplied or be available. Those skilled in the art should appreciate then when available category ratings for such records are required, none can be supplied.

The category ratings used in conjunction with the present invention may be generated by human beings which have reviewed the record involved and provided an analysis of the category or categories within which they believe the record belongs. As discussed above this type of analysis work can be subjective depending on who is actually doing the analysis, so a number of category records may preferably be provided for each record.

In a further preferred embodiment a category rating may include or consist of a list of categories which the system is designed to work with, and an indication of the probability of a record belonging to each category. In some instances this indication may take the form of simple yes or no, on or off, binary answers with regard to whether the record involved belongs to each of the categories specified. Alternatively, in other embodiments a category rating may consist of a list of possible categories and a probability value indicating the confidence that the record falls within each of the categories specified. Those skilled in the art should appreciate that the exact configuration or arrangement of category rating information may vary depending on the particular implementation of the present invention required.

Once the input data and associated category ratings have been obtained the machine leaning system may then identify each of the discrete features present in the input data records available. This may be executed as an iterative process starting with the first document supplied, identifying and working with each of its features and then continuing on with the next document supplied in turn.

Preferably once a feature of a document has been identified the feature data structure associated with or created by the machine learning system may be updated. The feature data structure may contain a plurality of elements, with each of these elements being linked to or associated with a particular feature which may appear or be present in the type of record to be analysed by the system. The feature data structure may be composed of a plurality of elements where these elements associate category ratings with features which may be present in a record.

Preferably each element of the feature data structure may, be adapted to include category rating information sourced from one or more records. Once a feature has been found within a record the category rating information associated with that record may then be placed within or used to update the element of the feature data structure associated with the feature involved. Preferably the category ratings associated with each element of the feature data structure may be stored in a cumulative form to give a distribution of weightings of categories which the feature is most likely to be indicative of.

As discussed above this sequence of operations may be completed for every identified feature within every record of the input learning data provided to the system. The feature data structure created or updated using the leaning data may provide a classified summary of the input data and category ratings broken down based on the features present within each of the records supplied.

According to a further aspect of the present invention there is provided a method of implementing a machine learning system through the creation of at least one feature data structure characterised by the steps of;

(i) obtaining input data formed from a number of discreet records, each record containing a plurality of features, and

(ii) obtaining at least one category rating for each record, wherein a category rating gives information relating to a category or categories which each record belongs to, and

(iii) identifying each of the features present within each record of the input data obtained, and

(iv) updating an element of a feature data structure associated with a particular feature identified with at least one category rating of the record in which the feature occurred, and

(v) updating a total data structure with at least one category rating of the record in which the feature identified occurred, and

(vi) continuing to update the elements of the feature data structure with each feature of each record making up the input data, and

(vii) continuing to update the total data structure for each record making up the input data.

In a further preferred embodiment an additional total data structure may also be created and maintained when learning data records are processed and used to update the feature data structure. Such a total structure may keep a cumulative record of category ratings considered without breaking these records down into separate elements based on the features present in each record. The total data structure may keep or record a cumulative total of category ratings considered for all of the input data records considered.

Reference throughout this specification will also be made to the machine learning system implementing or creating a single feature data structure formed from a number of elements, and preferably also forming a single total data structure. Those skilled in the art should appreciate that when software code is generated for the algorithms employed these general data structures may be organised in or be formed from a plurality of component data structures or organisations of data. Therefore, reference to the provision of a single feature data structure and a single total data structure throughout this specification should in no way be seen as limiting.

According to a further aspect of the present invention, there is provided a method of using a machine learning system employing a feature data structure, said method being characterised by the steps of,

(i) obtaining a sample record for which the probability of the record containing zero or more categories is to be indicated, and

(ii) identifying each of the features present within the sample record, and

(iii) supplying at least a portion of the elements of the feature data structure to a Naïve Bayesian prediction algorithm where the elements supplied are associated with features identified within the sample record, and

(iv) calculating an indication of the probability of the sample record belonging to zero or more categories using said Naïve Bayesian prediction algorithm.

According to another aspect of the present invention, there is provided a method of using a machine learning system substantially as described above, wherein the step of calculating an indication of the probability of a sample record belonging to zero or more categories is completed through summing the category ratings of the supplied elements of the feature data structure.

According to yet another aspect of the present invention there is provided a method of using a machine learning system substantially as described above, wherein the step of calculating an indication of the probability of a sample record belonging to zero or more categories it is completed through summing the logarithm of the category ratings of the selected elements of the feature data structure.

According to yet another aspect of the present invention there is provided a method of using a machine learning system substantially as described above, wherein the step of calculating an indication of the probability of a sample record belonging to zero or more categories it is completed through summing weighted logarithms of the category ratings of the selected elements of the feature data structure.

According to another aspect of the present invention there is provided a method of using a machine learning system employing a feature data structure, said method being characterised by the steps of:

(i) obtaining a sample record for which the probability of the record belongin to zero or more categories is to be indicated, and

(ii) identifying each of the features present within the sample record, and

(iii) assigning a priority value to each element of the feature data structure which is associated with a feature also identified in the sample record, and

(iv) selecting the most relevant elements of the feature data structure by applying a threshold test to each of the priority values assigned, and

(v) supplying the selected relevant elements of the feature data structure to a Naïve Bayesian prediction algorithm

(vi) calculating an indication of the probability of the sample record belonging to zero or more categories using said Naïve Bayesian prediction algorithm.

Preferably the present invention also encompasses a method of using a machine learning system substantially as described above by employing the data structure or structures it creates and updates.

Reference throughout this specification will also be made to the machine learning system being employed to calculate the probability of a sample data record falling within or belonging to one or more categories. In this application the present invention is employed within a filtering or pattern recognition system. However, those skilled in the art should appreciate that other applications are envisioned and reference to the above only throughout this specification should in no way be seen as limiting. For example, in some instances an indication of probability only may be calculated where a specific probability value is not required. In such instances the indication value calculated may be used to provide a ranking or prioritisation value for an input data record

Those skilled in the art should also appreciate that the present invention may also be used to calculate an indication of the probability of the sample record belonging to zero or more categories. For example, in some instances the system may indicate that the sample record in question is uncategorisable and therefore belongs to zero categories.

Preferably when the machine learning system of the present invention is employed, it is initially supplied with a sample data record which is to be analysed to determine the category or categories within which the record belongs. Preferably the output of the system may provide one or more probability values for the input record falling within one or more categories.

To complete this analysis the system may firstly identify each of the features present within the sample record. The features identified may then be used to retrieve or link to the elements of the feature data structure associated with each identified feature. These elements of the feature data structure (which contain category ratings for each of the features present within the input record) may then be used in the categorisation and analysis work required.

Preferably once the features of a sample record have been identified, a calculation of the probability of the sample record containing or belonging to one or more categories can be completed using a Naïve Bayesian prediction algorithm.

In a further preferred embodiment a probability distribution of categories may be calculated from each of the elements of the feature data structure selected. An algorithm may compute the product of all probabilities for each specified category to give a final probability distribution over all categories for the sample record considered. The probability distribution may then be renormalized (if required) so that all the probabilities specified for sum to one.

However, those skilled in the art should appreciate that other forms of executing the prediction algorithm required need not necessarily rely on the above calculation. For example, in an alternative embodiment the logarithms of the content of the category rating or ratings for each supplied feature may be summed. Many different types of probability indicating calculations may be completed using this process, as illustrated through the equations set out below;

Q=Πpi₄

Q=Σlog(pi)

Q=Σv*log(pi)

Q=Σv*log (^{pi}/r)

Q=Σv*log (^{pi}/1−pi)

Q=Σv*log ((^{pν}1−pi)* (^{r/}1−r))

Where;

Q is equal to the total value calculated,

pi is equal to the estimated probability value returned from category ratings for each element selected from the feature data structure,

v is equal to a weighting value,

r is equal to probability of the category being predicted taken over all the original input records used to generate the feature data structure

These values can be used to directly rank a set of input records or alternatively, to further calculate a probability for an input record belonging to one or more categories. The actual final value or number calculated will be determined by the application in which the present invention is used.

In some instances the logarithm of the content of the category rating or ratings for each supplied feature may be multiplied by a weighting value.

The weighting value of v employed may also be calculated in a number of different ways. For example, in some instances v may be taken to equal 1/ε1 where s is an estimate of either the standard deviation or the variance of the value of log (pi), or log (^{pi}/1−pi), depending on the form of sum being used. Such estimates of s can be made in a number of different ways, with varying accuracy and performance.

Probability values may also be extracted or calculated in a number of different ways if required. The exponent of the final sum of logarithms can be calculated in some instances to give probability values. Alternatively, a probability indication can be calculated from a summation of calibrated summed weighted logarithms of the content of the category rating or ratings for each supplied feature. For example, in one embodiment calibration may be completed through dividing the range of the weighted sums covered into discreet buckets or regions, and to count the probability of each category within the buckets. The actual probability can then be computed by determining which bucket a particular weighted sum falls in to and then returning the general probability range for that bucket. The accuracy or resolution of probability values returned can also be varied through varying the number of buckets and their widths or positions within the range covered.

Preferably the Naïve Bayesian algorithm employed need not necessarily be supplied with or act on all of the elements of the featured data structure. In some instances, a selection of the most relevant elements of the featured data structure may be made if required.

For example, in a preferred embodiment a single numeric value may be calculated for each identified element of the feature data structure.

The accumulated category ratings of the element may be subtracted from the total category rating of the total data structure maintained to give a complementary element. A category probability distribution that gives non-zero values for all categories may be calculated for both the selected element and its complement. An initial value yᵢ can then be calculated for each category from information supplied from both the element and its complement, as shown below;

yᵢ=−(w* log(p)+g*log(q))

where

w is the total weight or rating assigned to the category within the element,

p is the probability of the category appearing from the probability distribution calculated from the element,

g is the total weight or rating of the category supplied from the complement of the element, and

q is the probability for the category appearing in the probability distribution of the element's complement,

log ( ) is the logarithmic function extended so that 0*log(0)=0.

Each of the values of yᵢ calculated over all the categories to be considered can then be summed together to give the final priority value calculated for the particular element analysed, so that the priority value will equal Σy₁

However, those skilled in the art should appreciate that a number of different methods of assigning a priority value to each element may also be executed and used in accordance with the present invention. Reference to the above only throughout this specification should in no way be seen as limiting.

For example in one alternative embodiment the value yᵢ as calculated above may simply be determined through the use of the formula—

yᵢ=−w*log(p)

This replacement formula has the advantage in that it gives a more approximate but faster result than the original formula discussed above, where the priority value calculated will still equal Σyᵢ.

In yet another alternative embodiment the value yᵢ discussed above may be calcuated using the formula—

y=−(w*log(p)+g*log(q)+s

where s is a weighted estimate of the standard deviation in computing the original y.

Preferably, once a priority value has been assigned to each identified element of the feature data structure, the most relevant of these elements may be selected by applying a threshold test using each of the priority values assigned. This threshold test may simply select the identified elements of the feature data structure which have the highest or lowest priority value (for example) and remove non selected elements from further consideration. The threshold test or value employed may vary depending on the configuration of the machine learning system, the application it is adapted to perform within, or the amount of learning data which has previously been supplied to the system.

According to a further aspect of the present invention there is provided a method of testing an automated learning system using the learning data employed by the system, characterised by the steps of:

(a) selecting a test record from learning data used to create a feature data structure of the system, and

(b) subtracting the test records category rating or ratings from a total data structure of the system, and

(c) identifying the features present in the test record, and

(d) subtracting the test records category rating or ratings from elements of the feature data structure associated with each feature identified within the test record, and

(e) using the updated feature data structure, updated total data structure, and test record as inputs to a Naïve Bayesian prediction algorithm to calculate a probability indication for a category or categories which the test record may belong to, and

(f) comparing a calculated probability indication with the category rating or ratings of the test record.

Preferably the present invention may also encompass an improved method of testing a machine learning system. Such a machine learning system may be formed substantially as described above, but those skilled in the art should appreciate this methodology may be employed with other types of system if required. Reference to the specific components of the system employed in accordance with the present invention should in no way be seen as limiting.

In each instance the improved method of testing may subtract or remove the effect of one data record from the data structures employed by the system. This eliminates the need for the system to be tested on data that is distinct or separate from learning employed to create the systems data structure or structures. In essence this methodology may remove or leave out one of the learning data records from the accumulated system data structures and then supply the removed record as a test record to test the performance of the system.

Using such a methodology the updated system data structures and the test record selected may be supplied to a Naïve Bayesian prediction algorithm (for example) to calculate a probability distribution for categories which the record may belong to. The distribution calculated may then be compared to a category rating for the test record, or alternatively several category ratings for the test record to assess the overall prediction accuracy of the system.

The present invention may provide many potential advantages over prior art machine learning systems.

The present invention allows a machine learning system to be implemented using computer software algorithms. The system can, for example, learn to become more accurate with predictions as to the content or characteristics of particular data records supplied to it, and can also be significantly adapted or modified in many different ways to deal and work with a large numbers of different types of data records. Many different applications of the present invention are considered from recognition and filtering systems through to system modelling applications.

Furthermore, in preferred embodiments the selection of relevant elements of the feature data structure also allows the speed and accuracy of the system to be improved, or for the system to run on relatively low performance computer systems if required.

By providing an improved method of testing the accuracy of the system through subtracting previously used learning data records from the data structures used, this eliminates the need for an entirely independent set of test data to be created or purchased for use with the present invention. As can be appreciated by those skilled in the art this can significantly decrease the costs of developing and testing such systems.

### BRIEF DESCRIPTION OF DRAWINGS

Further aspects of the present invention will become apparent from the ensuing description which is given by way of example only and with reference to the accompanying drawings in which:

Further aspects of the present invention will become apparent from the following description that is given by way of example only and with reference to the accompanying drawings in which:

FIG. 1 shows a block schematic diagram of information flows and processes executed by a machine learning system formed in accordance with a preferred embodiment of the present invention when said system is receiving and processing learning data records; and

FIG. 2 shows a block schematic diagram of the information flows and processes executed by a machine learning system formed in accordance with a preferred embodiment of the present invention where the system is used to calculate a probability distribution of an input data record falling within a number of distinct categories, and

FIG. 3 shows a block schematic diagram of information flows and processes executed by the machine learning system formed in accordance with an alternative embodiment which is used to calculate an indication of a probability distribution with an alternative methodology to that discussed with respect to FIG. 2.

FIG. 4 shows a block schematic diagram of abstractions of the data structures to be employed in a preferred embodiment of the present invention

### BEST MODES FOR CARRYING OUT THE INVENTION

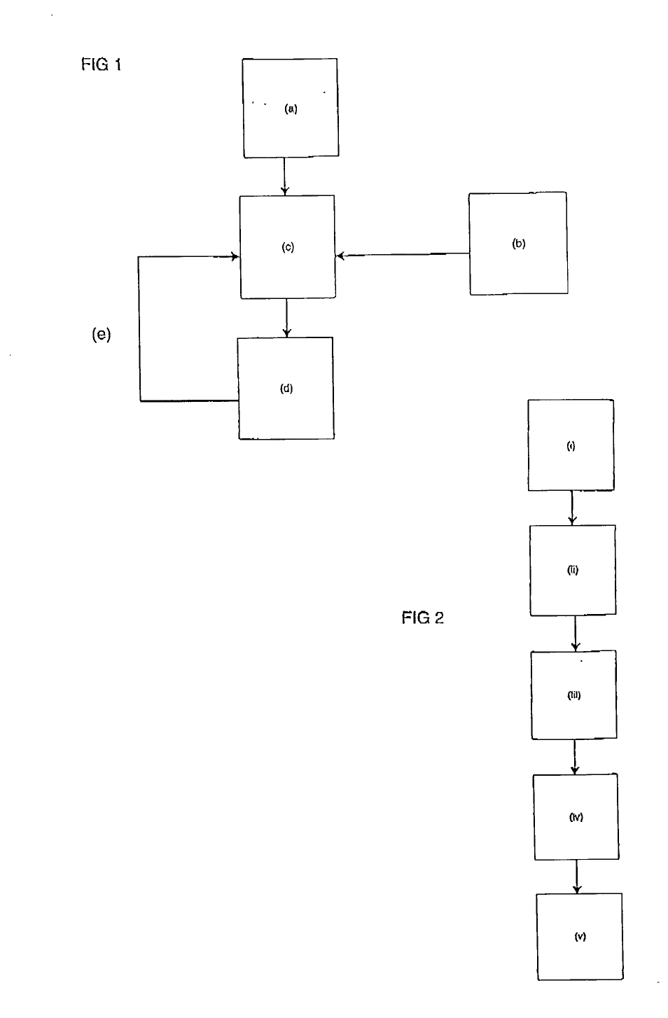

FIG. 1 shows a block schematic diagram of information flows and processes executed by a machine learning system formed in accordance with a preferred embodiment of the present invention.

In the instances shown with respect to FIG. 1 the machine learning system is handling information flows and completing processes required for the system to receive and process learning data records.

The first block A represented indicates the machine learning system obtaining data formed from a number of discrete records. This data is provided to the system to allow it to “learn” through analysing the content of each record. Each of the learning data records provided contain a plurality of features, and each record also belongs to at least one specific category.

Stage B represents the system obtaining or receiving information relating to a category rating for each record supplied in step A. A category record is formed from information particular to each record and gives information relating to the categories to which each record belongs to. Multiple category ratings are also provided for each record supplied in stage A. As the classification of the category or categories which a record may fall within is a subjective process, multiple category ratings are provided for each record generated by a number of different people.

At stage C the first of the input records obtained are analysed to identify the first features present in the records. The features of the record will depend on the type of information or data contained within the record. For example, in a preferred embodiment where a record is formed from a text document the features of the document are formed from the words it contains.

For each feature identified within the first record of step C an element of a feature data structure associated with the particular feature identified is updated at stage D. The element of the feature data structure is updated with the category rating of the record in which the feature occurred. Through updating the elements of the feature data structure particular to identified features, the category ratings of the records involved are stored in a data structure which differentiates between the particular features of a record.

Stage E represented by the looping arrow shown indicates the repetition of stages C and D for each learning record obtained and for each identified feature within each learning record. A cyclic approach is taken with respect to the above method by the first record obtained having all of its features analysed and processed as discussed above, followed by the second record and so forth.

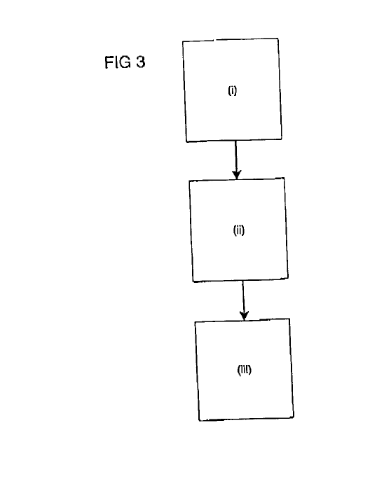

FIG. 2 shows a block schematic diagram of the information flows and processes executed by a machine learning system formed in accordance with a preferred embodiment of the present invention, where the system is executing the steps involved with completing a probability calculation.

The first stage (i) to be completed indicates the system obtaining an input record for which the probability of the record containing one or more categories is to be calculated.

At the next stage (ii) of the method executed, each of the features present in the input record are identified.

The following stage (iii) of this method is completed through identifying the elements of the feature data structure employed by the system which are associated with features identified within the input record. Once these elements of the feature data structure have been identified, they are assigned a priority value, weighting or ranking with respect to the others identified.

At the next stage (iv) of this method a selection of the most relevant elements of the feature data structure is made by applying a threshold test to each of the priority values assigned to each element identified. A subset of relevant elements associated with particular features are isolated from the main feature data structure maintained by the system at this stage.

The last stage of the prediction method is a calculation of the probability of an input record containing one or more categories. This calculation is completed by supplying the subset of relevant elements of the feature data structure to a Naïve Bayesian prediction algorithm. A probability distribution of the categories to be investigated by the system is initially calculated. A summation algorithm is then employed to compare the product of all probabilities for each specified category to give a final sum probability distribution over all categories for the single input record considered. This distribution will then indicate the likelihood of the input record belonging to any of the categories considered by the system.

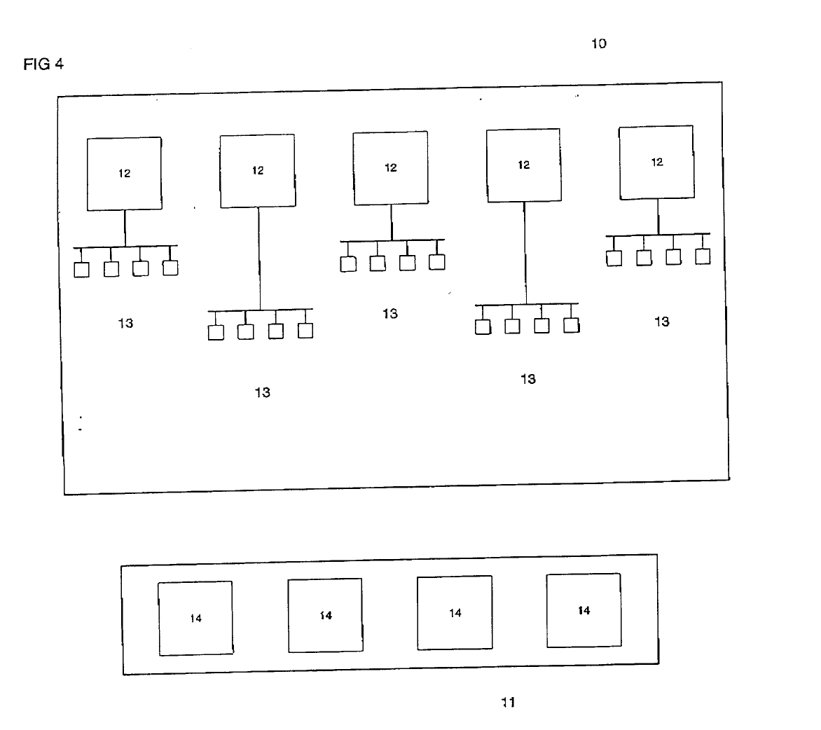

FIG. 3 shows a block schematic diagram of information flows and processes executed by a machine learning system provided in an alternative embodiment which is used to calculate an indication of a probability distribution. An alternative methodology to that discussed with respect to FIG. 2 is discussed.

In the situation shown with respect to FIG. 3 an indication of probability distribution only is required, not specific probability values. The indication of probability calculated can be used (for example) as a relative reference value to rank or prioritise a set of input data records with respect to a particular information category or categories. The processes executed for one input data record is discussed below.

The first and second stages of this process are essentially the same as that discussed with respect to FIG. 2, where the input record is obtained and the features present in the input record are identified. However, in the instance shown no prioritisation or selection of specific elements of the feature data structure are made as the third and fourth steps. In this embodiment the entire feature data structure is employed in calculation of a probability indication. However, those skilled in the art should appreciate that in other implementations of the present invention the selection of more relevant elements of the feature data structure may also be made if required.

In the embodiment shown with respect to FIG. 3, once each of the features present on the input record are identified, a Naïve Bayesian prediction algorithm is executed. In this instance the algorithm executes a summation function as shown below:

Q=Σv*log(pi)

Q the probability indication value, is calculated from a sum of the logarithms of the estimated probability values returned from each element of the feature data structure, where each logarithm is multiplied by weighting factor v.

The probability indication Q need not necessarily be converted into a specific probability value for a probability distribution as discussed above. This value Q may simply be used in a ranking or ordering process to assign a relative priority value to the input record involved.

FIG. 4 shows block schematic diagrams of abstractions of the data structures to be employed in accordance with a preferred embodiment of the present invention. The first data structure 10 shown with respect to FIG. 4 represents a feature data structure employed by the machine learning system discussed above. A total data structure 11 is also represented with respect to FIG. 4.

The feature data structure 10 is composed of five separate and distinct elements 12 with each element associated with or defined by a particular feature which may be present within a record to be considered. Each of the elements provide a mechanism by which the feature data structure 10 can subcategorise information using the features of a record.

Associated with each element 12 are a number of category weightings 13. In the instance shown four categories only are to be considered by the machine leaning system. Each element stores weighting or rating information particular to the categories considered by the system. When the feature data structure 10 is created or updated, the presence of a particular feature which is associated with an element 12 will cause each of the category components 13 of the element to be updated with the category rating of the record which contained the feature identified.

Conversely the total data structure 11 does not employ any distinctions with respect to particular features which may be present in a record. The total data structure simply contains information relating to each of the categories 14 to be considered by the system in an overall total weighting or probability distribution of each of these categories occurring within a record, irrespective of any analysis of the features present within the record.

Aspects of the present invention have been described by way of example only and it should be appreciated that modifications and additions may be made thereto without departing from the scope thereof,

Aspects of the present invention have been described by way of example only and it should be appreciated that modifications and additions may be made thereto without departing from the scope thereof as defined in the appended claims.

What we claim is:

1. A method of implementing a machine learning system through the creation of at least one feature data structure, characterised by the steps of;
(i) obtaining input data formed from a number of discreet records, each record containing a plurality of features, and
(ii) obtaining available category ratings for each record, wherein a category rating gives information relating to a category or categories which the record belongs to, and
(iii) identifying each of the features present within each record of the input data obtained, and
(iv) updating an element of a feature data structure associated with a particular feature identified with any category rating available for the record in which the feature occurred, and
(v) continuing to update the elements of the feature data structure with each feature of each record making up the input data.

2. A method of implementing a machine learning system through the creation of at least one feature data structure, charactexised by the steps of;
(i) obtaining input data formed from a number of discreet records, each record containing a plurality of features, and
(ii) obtaining at least one category rating for each record, wherein a category rating gives information relating to a category or categories which each record belongs to, and
(iii) identifying each of the features present within each record of the input data obtained, and
(iv) updating an element of a feature data structure associated with a particular feature identified with at least one category rating of the record in which the feature occurred, and
(v) continuing to update the elements of the feature data structure with each feature of each record making up the input data.

3. A method of implementing a machine learning system through the creation of at least one feature data structure characterised by the steps of;
(i) obtaining input data formed from a number of discreet records, each record containing a plurality of features, and
(ii) obtaining at least one category rating for each record, wherein a category rating gives information relating to a category or categories which each record belongs to, and
(iii) identifying each of the features present within each record of the input data obtained, and
(iv) updating an element of a feature data structure associated with a particular feature identified with at least one category rating of the record in which the feature occurred, and
(v) updating a total data structure with at least one category rating of the record in which the feature identified occurred, and
(vi) continuing to update the elements of the feature data structure with each feature of each record making up the input data, and
(vii) continuing to update the total data structure for each record making up the input data.

4. A method of implementing a machine learning system as claimed in claim 3, wherein the total data structure keeps a cumulative record of category ratings considered for all input data records considered.

5. A method of implementing a machine learning system as claimed in claim 1, which employs at least one software based algorithm adapted to receive input data.

6. A method of implementing a machine learning system as claimed in claim 1, wherein said at least one feature data structure increases in size with the supply of further input learning data.

7. A method of implementing a machine learning system as claimed in claim 1, wherein input data records contain a plurality of distinct features.

8. A method of implementing a machine learning system as claimed in claim 1, wherein each of the features present within each record of the input data are identified in an iterative process.

9. A method of implementing a machine learning system as claimed in claim 1, wherein the feature data structure is composed of a plurality of elements where each element is linked to a particular feature which may be present in the record to be analysed.

10. A method of implementing a machine learning system as claimed in claim 1, wherein said at least one feature data structure is composed of a plurality of elements, said elements associating category ratings with features which may be present within a record.

11. A method of implementing a machine learning system as claimed in claim 1, wherein each element of the feature data structure is adapted to include category rating information sourced from one or more records.

12. A method of implementing a machine learning system as claimed in claim 11, wherein category ratings associated with each element of the feature data structure are stored in a cumulative form providing distributed weightings of categories which the feature is most likely to be indicative of.

13. A method of implementing a machine learning system as claimed in claim 2, wherein an input data record belongs to at least one category, where a category gives a classification of the content of the record.

14. A method of implementing a machine learning system as claimed in claim 2, wherein a single data record can belong to multiple categories, with said categories being defined by the application in which the machine learning system is used within.

15. A method of implementing a machine learning system as claimed in claim 1, wherein a category rating includes information regarding the category or categories which the record may belong to.

16. A method of implementing a machine learning system as claimed in claim 15, wherein a category rating includes a list of categories and an indication of the probability of a record belonging to each category.

17. A method of implementing a machine learning system as claimed in claim 1, wherein multiple category ratings are provided for the same record from different sources.

18. A method of implementing a machine learning system as claimed in claim 1, wherein category ratings are generated by human beings who have reviewed the record and provided an analysis of the categories which they believe the record belongs to.

19. A method of using a machine learning system employing a feature data structure, said method being characterised by the steps of;
(i) obtaining a sample record for which the probability of the record belonging to zero or more categories is to be indicated, and
(ii) identifying each of the features present within the sample record, and
(iii) supplying at least a portion of the elements of the feature data structure to a Naïve Bayesian prediction algorithm where the elements supplied are associated with features identified within the sample record, and
(iv) calculating an indication of the probability of the sample record belonging to zero or more categories using said Naïve Bayesian prediction algorithm.

20. A method of using a machine learning system, as claimed in claim 19, wherein the step of calculating an indication of the probability of a sample record belonging to zero or more categories is completed through summing the category ratings of the supplied elements of the feature data structure.

21. A method of using a machine learning system, as claimed in claim 19, wherein the step of calculating an indication of the probability of a sample record belonging to zero or more categories is completed through summing the logarithm of the category ratings of the selected elements of the feature data structure.

22. A method of using a machine learning system, as claimed in claim 19, when the step of calculating an indication of the probability of a sample record belonging to zero or more categories is complete through summing weighted logarithms of the category ratings of the supplied elements of the feature data structure.

23. A method of using a machine learning system employing a featured data structure, said method being characterised by the steps of;
(i) obtaining a sample record for which the probability of the sample record belonging to zero or more categories is to be indicated, and
(ii) identifying each of the features present within the sample record, and
(iii) assigning a priority value to each element of the feature data structure which is associated with a feature also identified in the sample record, and
(iv) selecting the most relevant elements of the feature data structure by applying a threshold test to each of the priority values assigned, and
(v) supplying the selected relevant elements of the feature data structure to a Naïve Bayesian prediction algorithm
(vi) calculating an indication of the probability of the sample record belonging to zero or more categories using said Naïve Bayesian prediction algorithm.

24. A method of using a machine learning system as claimed in claim 23, wherein said system is employed to calculate the probability of a sample data record belonging to zero or more categories.

25. A method of using a machine learning system as claimed in claim 23, wherein the probability indication provides a probability distribution which is re-normalised so all probability can be summed to one.

26. A method of using a machine learning system as claimed in claim 23, where the content of the category rating or ratings for each supplied feature is summed to give a probability distribution over all categories for the sample record considered.

27. A method of using a machine learning system as claimed in claim 23, wherein the logarithm of the content of the category rating or ratings for each supplied feature is summed to provide a probability indication.

28. A method of using a machine learning system as claimed in claim 27, wherein the logarithm of the content of the category rating or ratings for each supplied feature are multiplied by a weighting value.

29. A method of using a machine learning system as claimed in claim 28, wherein said weighting value is equal to an estimate of the standard deviation or the variance of the logarithm of the content of the category rating or ratings for each supplied feature.

30. A method of using a machine learning system as claimed in claim 23, wherein a probability indication is calculated from a summation of calibrated summed weighted logarithms of the content of the category rating or ratings for each supplied feature.

31. A method of using a machine learning system as claimed in claim 30, wherein said calibration is completed through dividing the range of weighted sums covered into discreet regions, wherein the probability indication returned is the general probability range of the region involved.

32. A method of using a machine learning system as claimed in claim 23, wherein the priority value assigned to each element of the feature data structure is equal to Σyᵢ
where yᵢ=−(w*log(p)+g*log(q)),
yᵢ being calculated for each category considered within the element's category rating or ratings, and
w is the total weight or rating assigned to the category within the element,
p is the probability of the category appearing from the probability distribution calculated from the element,
g is the total weight or rating of the category supplied from the complement of the element, and
q is the probability for the category appearing in the probability distribution of the element's complement,
log ( ) is the logarithmic function extended so that 0*log (0)=0.

33. A method of using a machine learning system as claimed in claim 23, wherein the priority value assigned to each element of the feature data structure is equal to Σyᵢ where
yᵢ=−W*log(p),
yᵢ being calculated for each category considered within the element's category rating or ratings, and
w is the total weight or rating assigned to the category within the element,
p is the probability of the category appearing from the probability distribution calculated from the element,
log ( ) is the logarithmic function extended so that 0*log (0)=0.

34. A method of testing a machine learning system using learning data employed by the system characterised by the steps of;
(i) selecting a test record from input data used to create a feature data structure of the system, and
(ii) subtracting the test records category rating or ratings from a total data structure of the system, and
(iii) identifying the features present in the test record, and
(iv) subtracting the test record's category rating or ratings from the elements of the feature data structure associated with each element identified within the test record, and
(v) using the updated feature data structure, updated total data structure and test record as inputs to a Naïve Bayesian prediction algorithm to calculate a probability indication for a category or categories which the test record may belong to, and
(vi) comparing a calculated probability indication with the category rating or ratings of the test record.

35. A method of testing an automated learning system as claimed in claim 34, wherein the probability indication calculated is compared to a category rating or ratings for the test record to assess the overall prediction accuracy of the system.
